(19) United States
(12) Patent Application Publication
(10) Pub. No.: US 2025/0339860 A1
(43) Pub. Date: Nov. 6, 2025

(54) Systems for Monitoring Fluidics in Reagent Cartridges and Related Methods

(71) Applicant: Illumina, Inc., San Diego, CA (US)

(72) Inventors: Wesley A. Cox-Muranami, Middleton, WI (US); Cameron Mar, San Diego, CA (US); Cyril Delattre, San Diego, CA (US); Paul Crivelli, San Diego, CA (US); Kamal Shah, Seattle, WA (US); Kirkpatrick W. Norton, San Diego, CA (US)

(21) Appl. No.: 19/269,135

(22) Filed: Jul. 15, 2025

Related U.S. Application Data
(62) Division of application No. 17/115,454, filed on Dec. 8, 2020.
(60) Provisional application No. 62/955,160, filed on Dec. 30, 2019.

(51) Int. Cl. B01L 3/00; G01N 27/327

(52) U.S. Cl. CPC B01L 3/527; G01N 27/3275; B01L 2200/04; B01L 2200/16; B01L 2300/022; B01L 2300/0645; B01L 2300/0816; B01L 2300/0861; B01L 2400/0487

(57) ABSTRACT

Systems for monitoring fluidics in reagent cartridges and related methods. An apparatus includes a system includes a reagent cartridge receptacle and a flow cell assembly. The apparatus includes a reagent cartridge receivable within the reagent cartridge receptacle and adapted to carry the flow cell assembly. The reagent cartridge includes a reagent reservoir fluidically coupled to the flow cell assembly. The apparatus includes a sensor module adapted to be positioned adjacent the reagent reservoir. The sensor module is adapted to generate a signal associated with a volume of reagent contained within the reagent reservoir.

### CROSS-REFERENCE TO RELATED APPLICATIONS

This application claims priority to U.S. application Ser. No. 17/115,454, filed Dec. 8, 2020, which claims priority to U.S. Provisional Application No. 62/955,160, filed Dec. 30, 2019, the content of which is incorporated by reference herein in its entirety and for all purposes.

### BACKGROUND

Sequencing platforms may include valves and pumps. The valves and pumps may be used to perform various fluidic operations.

### SUMMARY

In accordance with a first implementation, an apparatus comprises or includes a system comprising or including a reagent cartridge receptacle. The apparatus includes a flow cell assembly. The apparatus comprises or includes a reagent cartridge receivable within the reagent cartridge receptacle and adapted to carry the flow cell assembly. The reagent cartridge comprises or includes a reagent reservoir adapted to be fluidically coupled to the flow cell assembly. The apparatus comprises or includes a sensor module adapted to be positioned adjacent the reagent reservoir. The sensor module is adapted to generate a signal associated with a volume of reagent contained within the reagent reservoir.

In accordance with a second implementation, an apparatus comprises or includes a flow cell assembly. The apparatus comprises or includes a reagent cartridge adapted to carry the flow cell assembly. The reagent cartridge comprises or includes a reagent reservoir adapted to be fluidically coupled to the flow cell assembly. The reagent cartridge comprises or includes a sensor electrode associated with the generation of a signal associated with at least one of a volume of reagent within the reagent reservoir, a presence of reagent, or a reagent flow rate value.

In accordance with a third implementation, an apparatus comprises or includes a flow cell assembly and a reagent cartridge adapted to carry the flow cell assembly. The reagent cartridge comprising or including a reagent reservoir adapted to be fluidically coupled to the flow cell assembly. The apparatus comprises or includes a sensor electrode associated with the generation of a signal associated with at least one of a volume of reagent within the reagent reservoir, a presence of reagent, or a reagent flow rate value.

In accordance with a fourth implementation, a method comprises or includes flowing reagent from a reagent reservoir to a flow cell assembly and generating a signal associated with reagent contained within the reagent reservoir. The method comprises or includes based on the signal, determining a volume of the reagent within the reagent reservoir.

In accordance with a fifth implementation, an apparatus comprises or includes a system comprising or including a reagent cartridge receptacle; a sensor module; and a controller operatively coupled to the sensor module. The apparatus comprises or includes a flow cell assembly. The apparatus comprises or includes a reagent cartridge receivable within the reagent cartridge receptacle and adapted to carry the flow cell assembly. The reagent cartridge comprises or includes a reagent reservoir containing reagent and a fluidic line coupled to the reagent reservoir and the flow cell assembly. The apparatus comprises or includes a pressure source adapted to apply a pressure to the reagent reservoirs. The sensor module is adapted to generate a signal associated with a reagent flow rate value and the controller is adapted to compare the determined reagent flow rate value to a reference flow rate value. When the determined reagent flow rate value is outside of a threshold range of the reference flow rate value, the controller may cause the pressure applied to one or more of the reagent reservoirs to change thereby enabling a subsequent reagent flow rate value to be within the threshold value of the reference flow rate value.

In accordance with a sixth implementation, an apparatus comprises or includes a flow cell assembly and a reagent cartridge receivable within a reagent cartridge receptacle of a system and adapted to carry the flow cell assembly. The reagent cartridge comprises or includes a plurality of reagent reservoirs; a common fluidic line; and a plurality of reagent fluidic lines. Each reagent fluidic line is coupled to a corresponding reagent reservoir. The reagent cartridge comprises or includes a portion of a sensor module adapted to interface with another portion of the sensor module of the system and associated with the generation of a signal associated with a reagent flow rate value.

In accordance with a seventh implementation, a method comprises or includes pressurizing a reagent reservoir containing reagent; flowing the reagent through a reagent fluidic line to a common fluidic line; determining a reagent flow rate value; comparing the determined reagent flow rate value to a reference flow rate value; and when the determined reagent flow rate value is outside of a threshold range of the reference flow rate value, changing the pressure applied to the reagent reservoir to enable a subsequent reagent flow rate value to be within the threshold range of the reference flow rate value.

In accordance with an eighth implementation, an apparatus comprises or includes a reagent cartridge adapted to carry a flow cell assembly. The reagent cartridge comprising or including a reagent reservoir adapted to be fluidically coupled to the flow cell assembly. The apparatus comprises or includes a sensor electrode associated with the generation of a signal associated with at least one of a volume of reagent within the reagent reservoir, a presence of reagent, or a reagent flow rate value.

In further accordance with the foregoing first, second, third, fourth, fifth, sixth, and/or seventh implementations, an apparatus and/or method may further include or comprise any one or more of the following:

In an implementation, the system comprises or includes a controller adapted to access the signal from the sensor module. The controller is adapted to determine a flow rate from the reagent reservoir based on the volume within the reagent reservoir over time.

In another implementation, the controller is adapted to compare the determined reagent flow rate value to a reference flow rate value. When the determined reagent flow rate value is outside of a threshold range of the reference flow rate value, the controller is adapted to change an operating parameter of the system.

In another implementation, the operating parameter comprises or includes an amount of time that the reagent is flowed from the reagent reservoir.

In another implementation, the operating parameter comprises or includes a pressure applied to the reagent reservoir.

In another implementation, further comprising or including a pressure source adapted to apply a pressure to the reagent reservoir.

In another implementation, further comprising or including a regulator coupled between the pressure source and the reagent reservoir. The controller is adapted to cause the regulator to change the pressure applied to the reagent reservoir.

In another implementation, the system comprises or includes the sensor module.

In another implementation, further comprising or including a sensor electrode adapted to be communicatively coupled to the sensor module.

In another implementation, the sensor electrode is wirelessly coupled to the sensor module.

In another implementation, further comprising or including a connector adapted to couple the sensor module and the sensor electrode.

In another implementation, the connector comprises or includes a male portion and a female portion. One of the male portion or the female portion is carried by reagent cartridge. The other of the male portion or the female portion is carried by the system.

In another implementation, the sensor electrode comprises or includes a pair of plates between which the reagent reservoir is positioned.

In another implementation, the sensor electrode comprises or includes a pair of plates between which the reagent reservoir is adapted to be positioned.

In another implementation, the sensor electrode is an annular electrode and surrounds the reagent reservoir.

In another implementation, the sensor electrode is an annular electrode and is adapted to surround the reagent reservoir.

In another implementation, the sensor electrode is carried by the reagent cartridge.

In another implementation, the sensor module comprises or includes a contact that connects the sensor module with the sensor electrode.

In another implementation, the sensor module comprises or includes a contact adapted to interface with the sensor electrode.

In another implementation, the contact comprises or includes a leaf spring contact.

In another implementation, the reagent cartridge comprises or includes a fluidic line and the sensor electrode is positioned adjacent the fluidic line.

In another implementation, further comprising the flow cell assembly, where the reservoir is fluidcally coupled to the flow cell assembly.

In another implementation, the sensor electrode comprises or includes conductive tape coupled to the reagent cartridge.

In another implementation, the sensor electrode comprises or includes a portion of the reagent reservoir or the reagent cartridge.

In another implementation, the sensor electrode comprises or includes a well filled with a conductive fluid and adjacent to the reagent reservoir.

In another implementation, the reagent reservoir comprises or includes a tapered portion.

In another implementation, the reagent reservoir comprises or includes an elongated portion.

In another implementation, the sensor module comprises or includes a capacitive sensor.

In another implementation, further comprising or including based on the volume of the reagent over time, determining a reagent flow rate value.

In another implementation, further comprising or including pressurizing the reagent reservoir.

In another implementation, further comprising or including comparing the determined reagent flow rate value to a reference flow rate value; and when the determined reagent flow rate value is outside of a threshold range of the reference flow rate value, changing the pressure applied to the reagent reservoir to enable a subsequent reagent flow rate value to be within the threshold range of the reference flow rate value.

In another implementation, the signal is associated with a height of the reagent contained within the reagent reservoir.

In another implementation, the signal is associated with an electrode of an array of electrodes, each electrode of the array of electrodes being positioned adjacent the reagent reservoir and being associated with a different volume of reagent within the reagent reservoir.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1A illustrates a schematic diagram of an implementation of a system in accordance with a first example of the present disclosure.

FIG. 1B illustrates a schematic diagram of another implementation of the system of FIG. 1A.

FIG. 1C illustrates another implementation of the flow cell assembly and the reagent cartridge of the system of FIG. 1A.

FIG. 2 is a schematic illustration of an implementation of the sensor module and the sensor electrode of FIG. 1, including a pair of plates.

FIG. 3 is a schematic illustration of another implementation of the sensor module and the sensor electrode of FIG. 1, including an annular electrode.

FIG. 4 is a schematic illustration of another implementation of the sensor module and the sensor electrode of FIG. 1, including a conductor and a contact.

FIG. 5 is a schematic illustration of another implementation of the sensor module and the sensor electrode of FIG. 1, including a pair of conductors and a pair of contacts.

FIG. 6 is a schematic illustration of the reagent reservoir, the sensor module, and the sensor electrode of FIG. 1, with the reagent reservoir including a tapered portion.

FIG. 7 is a schematic illustration of another implementation of the reagent reservoir, the sensor module, and the sensor electrode of FIG. 1, with the reagent reservoir including an elongate portion.

FIG. 8 is an implementation of the reagent reservoir of FIG. 1 having a flat portion.

FIG. 9 is another implementation of the reagent reservoir of FIG. 1.

FIG. 10 illustrates a pair of the sensor electrodes spaced apart and positioned adjacent an implementation of the common fluidic line of FIG. 1.

FIG. 11 illustrates an array of sensor electrodes positioned adjacent the common fluidic line of FIG. 10.

FIG. 12 illustrates another array of the sensor electrodes positioned adjacent the common fluidic line of FIG. 10.

FIG. 13 illustrates another arrangement of the sensor electrodes adjacent the common fluidic line of FIG. 10.

FIG. 14 illustrates an arrangement of the sensor electrodes adjacent an implementation of the reagent reservoir of FIG. 1.

FIG. 15 illustrates an array of the sensor electrodes including reference sensor electrodes adjacent the reagent reservoir of FIG. 14.

FIG. 16 illustrates an arrangement of the sensor electrodes adjacent the reagent reservoir 136 of FIG. 14.

FIG. 17 illustrates a flowchart for a method of determining a volume of reagent within the reagent reservoir of FIG. 1 or any of the other implementations disclosed herein.

FIG. 18 illustrates another flowchart for a method of determining a volume of reagent within the reagent reservoir of FIG. 1 or any of the other implementations disclosed herein.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

This disclosure is directed toward sensor modules that are used to determine reagent flow rates and/or a volume of reagent in a reagent reservoir. In one implementation, a system (such as a sequencing system) includes the sensor module and a controller operatively coupled to the sensor module. The system is adapted to receive a reagent cartridge.

The reagent cartridge is adapted to carry a flow cell assembly and includes a plurality of reagent reservoirs containing reagent, a common fluidic line, and a plurality of reagent fluidic lines. Each reagent fluidic line is adapted to be coupled to a corresponding reagent reservoir. The sensor module may be adapted to be positioned adjacent the reagent reservoir.

In operation, the sensor module is adapted to generate a signal associated with a volume of the reagent contained within the reagent reservoir. In some implementations, the controller is adapted to determine a flow rate from the reagent reservoir based on the volume within the reagent reservoir over time.

In some such examples, the controller is adapted to compare the determined reagent flow rate value to a reference flow rate value. The reference flow rate value may be stored in a memory. The threshold range may be stored in memory. When the determined reagent flow rate value is outside of a threshold range of the reference flow rate value, the controller is adapted to change an operating parameter of the system. Changing the operating parameter may be associated with changing an amount of time that the reagent is flowed from the reagent reservoir to allow for a threshold amount of the reagent to be pumped. In implementations in which the reagent reservoir is pressurized, changing the operating parameter may be associated with changing the pressure applied to the reagent reservoir to allow for a subsequent reagent flow rate value to be within the threshold range of the reference flow rate value.

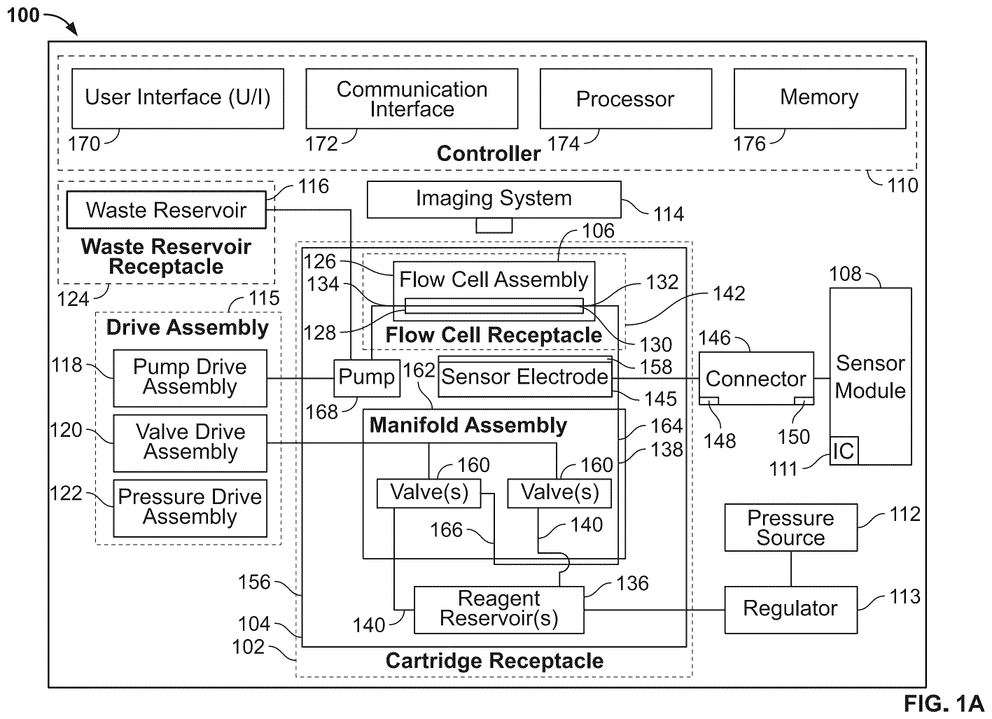

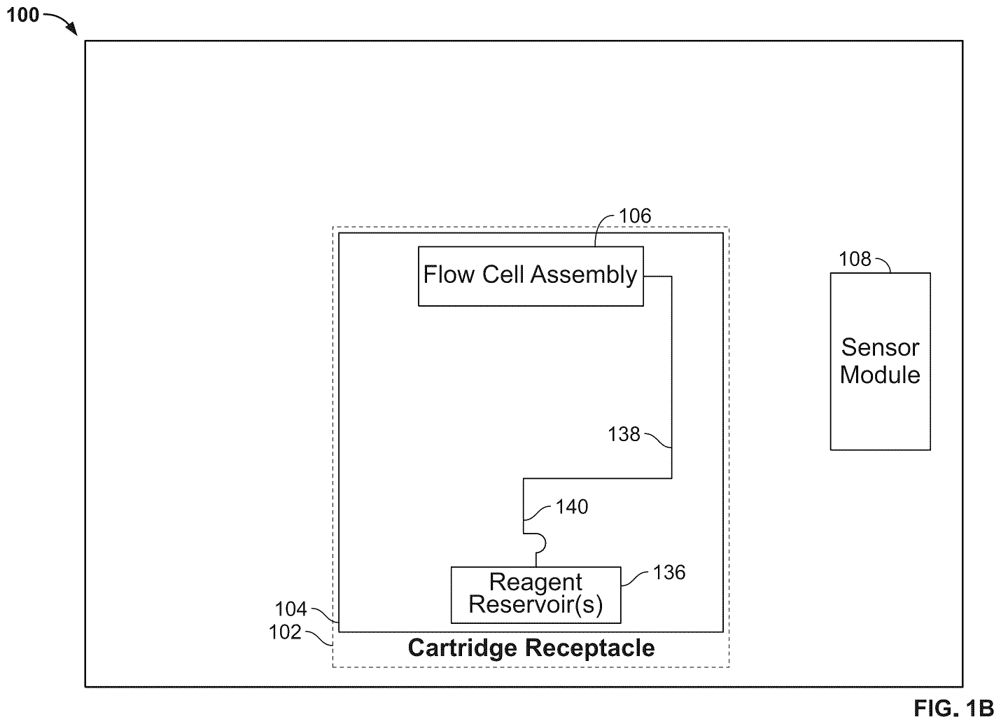

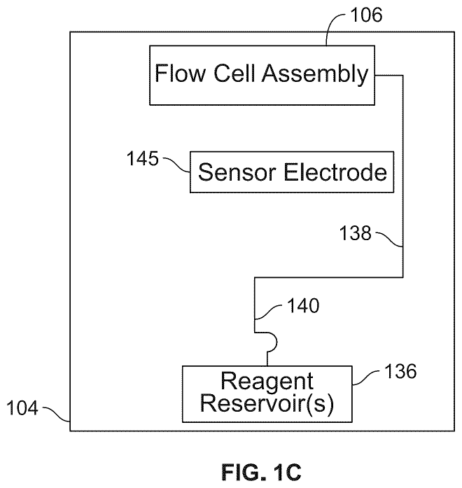

FIG. 1A illustrates a schematic diagram of an implementation of a system 100 in accordance with a first example of the present disclosure. The system 100 can be used to perform an analysis on one or more samples of interest. The sample may include one or more DNA clusters that have been linearized to form a single stranded DNA (sstDNA). In the implementation shown, the system 100 includes a reagent cartridge receptacle 102 that is adapted to receive a reagent cartridge 104. The reagent cartridge 104 carries a flow cell assembly 106.

In the implementation shown, the system 100 includes, in part, a sensor module 108 and a controller 110 operatively coupled to the sensor module 108. The sensor module 108 may include an integrated circuit (IC) 111. When the reagent cartridge 104 is carried by the system 100, the sensor module 108 may be positioned on the top of the reagent cartridge 104, on the side of the reagent cartridge 104, and/or on the bottom of the reagent cartridge 104. The sensor module 108 may include a touchless sensor such as, for example, a capacitive sensor and/or a non-contact capacitive level sensor. However, other types of sensors may prove suitable. For example, the sensor module 108 may include an optical sensor or a flow sensor.

The sensor module 108 may be adapted to generate a signal associated with fluid within the reagent cartridge 104. The signal may be associated with the volume of reagent within the reagent cartridge 104. The flow rate of the reagent may be associated with a volume of reagent over time. Some factors that may affect the flow rate of the reagent include impedance (e.g., impedance of fluidic lines), humidity, the flow cell assembly 106, manufacturing tolerances, ambient temperature, creep, water absorption, pressure (e.g., ambient pressure), and/or alignment. For example, different reagent cartridges 104 may have different impedances, sometimes referred to as cartridge-to-cartridge impedance variability. Other factors may also affect the flow rate of the reagent.

The signal may also be associated with bubbles within the system 100, the reagent cartridge 104, and/or the flow cell assembly 106. For example, the signal may be associated with bubbles being present/not present within the reagent cartridge 104. The signal may be associated with reagent being present/not present within, for example, the reagent cartridge 104.

In some implementations, the signal generated by the sensor module 108 may be used to determine a change in humidity, detect a presence of liquid, and/or to determine an effectiveness of flushing the flow cell assembly 106 with air (e.g., air flush) during a flushing operation. Humidity, if detected above a threshold value, may be associated with a leak. Detecting the presence of liquid in an area that is normally dry may be associated with a leak. In some implementations, the signal generated by the sensor module 108 may be used to determine an amount of remaining reagent within one or more of the fluidic lines, metering of the reagent, to determine if reagent is flowing as expected, to determine if the reagent is remaining at the top of the reagent reservoir 136, and/or to monitor mixing and/or the rehydrating of reagents. Other applications may prove suitable.

In some implementations, a higher signal-to-noise ratio may affect an accuracy of a parameter (e.g., the volume) determined. In some implementations, the signal-noise-ratio of the signal may be reduced in a number of ways. Some approaches to reduce signal-to-noise ratio may include increasing a height of the reagent reservoir, including an array of the sensor electrodes (see, for example, FIG. 15), and/or decreasing the spacing of the sensor electrodes and/or the associated voltage. Other approaches may include using a capacitance multiplier (pre-ADC capacitance multiplier that is transistor or op-amp based), driving the sensor electrodes with sinusoidal voltage, and/or by using a lock-in amplifier. Other approaches may prove suitable.

In the implementation shown, the system 100 also includes a pressure source 112. The pressure source 112 may, in some implementations, be used to pressurize the reagent cartridge 104. Pressurizing the reagent may be used to flow the reagent through the system 100, the reagent cartridge 104, and/or the flow cell assembly 106 under positive pressure. The pressure source 112 may alternatively be carried by the reagent cartridge 104 or may be external to the system 100.

Some factors may cause variation in the pressure applied and/or a resulting reagent flow rate value. Some of the factors that affect flow rate and/or the pressure include a height of the flow cell, manufacturing tolerances, lane cutting, ambient pressure, and/or temperature. Other factors may affect pressure applied and/or the resulting reagent flow rate value.

The system also includes a regulator 113, an imaging system 114, a drive assembly 115, and a waste reservoir 116. Alternatively, the regulator 113 may not be included. The drive assembly 115 includes a pump drive assembly 118, a valve drive assembly 120, and a pressure drive assembly 122. The controller 110 may be electrically and/or communicatively coupled to the drive assembly 115 and the imaging system 114 and is adapted to cause the drive assembly 115 and/or the imaging system 114 to perform various functions as disclosed herein. The waste reservoir 116 may be selectively receivable within a waste reservoir receptacle 124 of the system 100.

The reagent cartridge 104 carries one or more samples of interest. The drive assembly 115 interfaces with the reagent cartridge 104 to flow one or more reagents (e.g., A, T, G, C nucleotides) that interact with the sample through the reagent cartridge 104 and/or through the flow cell assembly 106.

In an implementation, a reversible terminator is attached to the reagent to allow a single nucleotide to be incorporated by the sstDNA per cycle. In some such implementations, one or more of the nucleotides has a unique fluorescent label that emits a color when excited. The color (or absence thereof) is used to detect the corresponding nucleotide. In the implementation shown, the imaging system 114 is adapted to excite one or more of the identifiable labels (e.g., a fluorescent label) and thereafter obtain image data for the identifiable labels. The labels may be excited by incident light and/or a laser and the image data may include one or more colors emitted by the respective labels in response to the excitation. The image data (e.g., detection data) may be analyzed by the system 100. The imaging system 114 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 115 interfaces with the reagent cartridge 104 to flow another reaction component (e.g., a reagent) through the reagent cartridge 104 that is thereafter received by the waste reservoir 116 and/or otherwise exhausted by the reagent cartridge 104. The reaction component performs a flushing operation that chemically cleaves the fluorescent label and the reversible terminator from the sstDNA. A flushing operation may also be performed using air. The sstDNA is then ready for another cycle.

The flow cell assembly 106 includes a housing 126 and a flow cell 128. The flow cell 128 includes at least one channel 130, a flow cell inlet 132, and a flow cell outlet 134. The channel 130 may be U-shaped or may be straight and extend across the flow cell 128. Other configurations of the channel 130 may prove suitable. Each of the channels 130 may have a dedicated flow cell inlet 132 and a dedicated flow cell outlet 134. A single flow cell inlet 132 may alternatively be fluidically coupled to more than one channel 130 via, for example, an inlet manifold. A single flow cell outlet 134 may alternatively be coupled to more than one channel via, for example, an outlet manifold.

In the implementation shown, the reagent cartridge 104 includes a plurality of reagent reservoirs 136, a common fluidic line 138, and a plurality of reagent fluidic lines 140. Alternatively, one reagent reservoir 136 and one reagent fluidic line 140 may be included. The reagent reservoirs 136 may contain fluid (e.g., reagent and/or another reaction component). The pressure source 112 may apply a pressure to the reagent reservoirs 136. Thus, a positive pressure from the pressure source 112 may be used to urge reagent through the system 100, the reagent cartridge 104, and/or the flow cell assembly 106.

Each reagent fluidic line 140 may be coupled to a corresponding reagent reservoir 136. The reagent cartridge 104 also includes a flow cell receptacle 142 and a manifold assembly 144. In other implementations, the manifold assembly 144 is part of the flow cell assembly 106 and/or part of the system 100.

In operation, the sensor module 108 may generate a signal associated with a volume of the reagent contained within the reagent reservoir 136. The controller 110 may be adapted to access the signal from the sensor module 108 and determine a flow rate value from the reagent reservoir 136 based on the volume within the reagent reservoir 136 over time.

The controller 110 may compare the determined reagent flow rate value to a reference flow rate value. In some implementations, when the determined reagent flow rate value is outside of a threshold range of the reference flow rate value, the controller 110 may change an operating parameter of the system 100. The operating parameter may include an amount of time that the reagent is flowed from the reagent reservoir 136. For example, if the determined reagent flow rate value is less than the reference flow rate value, the controller 110 may increase the amount of time that the reagent is flowed from the reagent reservoir 136 to allow for a threshold amount of the reagent to be pumped. Alternatively, if the determined reagent flow rate value is greater than the reference flow rate value, the controller 110 may decrease the amount of time that the reagent is flowed from the reagent reservoir 136 to allow for a threshold amount of the reagent to be pumped. In an implementation, the threshold range is between about approximately 100 microliters (μl) and about approximately 6000 μl. Other flow rates may prove suitable.

In other implementations, the operating parameter comprises a pressure applied to the reagent reservoir. The pressure may be applied using the pressure source 112. In such implementations, the controller 110 may change the pressure applied to one or more of the reagent reservoirs 136 to enable a subsequent reagent flow rate value to be within the threshold range of the reference flow rate value. For example, the controller 110 may cause the valve drive assembly 120, adapted to interface with the regulator 113, to control a pressure applied to the reagent reservoir 136. Thus, the controller 110 may cause the regulator 113 to change the pressure applied to one or more of the reagent reservoirs 136. The regulator 113 is positioned between the pressure source 112 and the reagent reservoirs 136. However, the regulator 113 may be in a different position or omitted entirely.

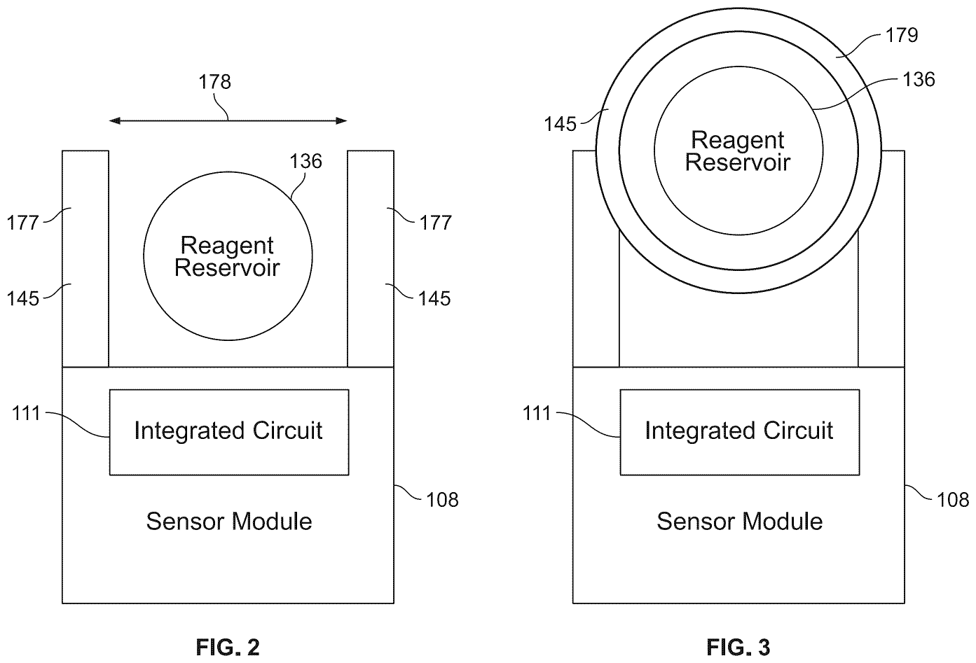

In the implementation shown, the reagent cartridge 104 includes a sensor electrode 145. Thus, the sensor electrode 145 may be carried by the reagent cartridge 104. The sensor electrode 145 is communicatively coupled to the sensor module 108. The sensor electrode 145 may be coupled to the sensor module 108 via a physical connection or a wireless connection. In other implementations, the sensor electrode 145 may be carried by the system 100 (see, for example, FIGS. 2 and 3). In such implementations, the sensor electrode 145 may be a pair of prongs or plates (see, FIG. 2) or may be annular (see., FIG. 3).

In the implementation shown, a connector 146 couples the sensor module 108 and the sensor electrode 145. The connector 146 may be an edge connector, a plug/socket connector, or pogo pins. When the connector 146 is a two-component connector (e.g., a plug/socket connector), the connector 146 may include a female portion 148 and a male portion 150. One of the male portion 150 or the female portion 148 can be carried by reagent cartridge 104 and the other of the male portion 150 or the female portion 148 can carried by the system 100.

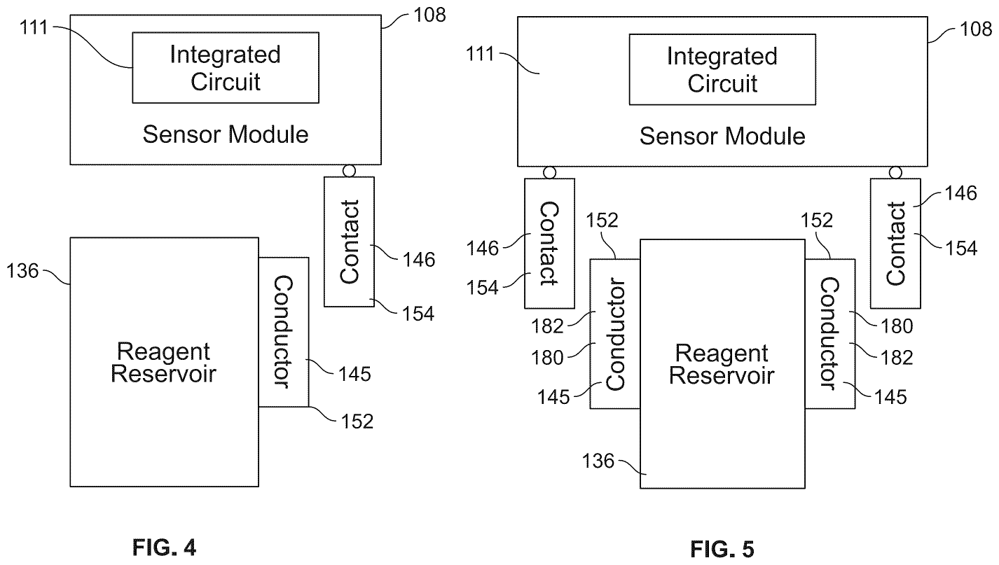

In another implementation, the reagent cartridge 104 carries the sensor electrode 145 and the system 100 carries the connector 146 (see, for example, FIGS. 4 and 5). In such implementations, the sensor electrode 145 may include a conductor 152 (see, FIGS. 4 and 5) and the connector 146 includes a contact 154 (see, FIGS. 4 and 5). The contact 154 may be adapted to interface with the conductor 152. The contact 154 may be a leaf spring contact connector. Other types of contacts 154 may prove suitable.

The reagent cartridge 104 includes a reagent cartridge body 156. The reagent cartridge body 156 may carry the sensor electrode 145. For example, the sensor electrode 145 may be housed within the reagent cartridge body 156, may be coupled to the outside of the reagent cartridge body 156, or may be embedded within the reagent cartridge body 156. Adhesive or a clip may be used to couple the sensor electrode 145 to the outside of or otherwise to the reagent cartridge body 156. If the sensor electrode 145 is carried on the outside of the reagent cartridge body 156, the reagent cartridge body 156 may define a sensor electrode receptacle 158. The sensor electrode receptacle 158 may be adapted to receive the sensor electrode 145. The sensor electrode receptacle 158 may be a groove.

The reagent cartridge body 156 may be formed of solid plastic using injection molding techniques and/or additive manufacturing techniques. In some implementations, the reagent reservoirs 136 are integrally formed with the reagent cartridge body 156. In other implementations, the reagent reservoirs 136 are separately formed and are coupled to the reagent cartridge body 156.

In the implementation shown, the manifold assembly 144 includes a plurality of valves 160. The valves 160 may include pinch valves, rotary valves, membrane valves, Belleville valves, and/or linear valves. Other types of valves 160 may prove suitable. The manifold assembly 144 fluidically couples the common fluidic line 138 and each of the reagent fluidic lines 140. Each valve 160 is coupled between the common fluidic line 138 and a corresponding reagent fluidic line 140. In operation, the valve drive assembly 120 is adapted to interface with the valves 160 to control a flow of reagent between the reagent fluidic lines 140 and the common fluidic line 138.

The manifold assembly 144 includes a manifold body 162. The manifold body 162 may be formed of polypropylene. The manifold body 162 defines a portion 164 of the common fluidic line 138 and a portion 166 of the reagent fluidic lines 140.

The flow cell receptacle 142 is adapted to receive the flow cell assembly 106. Alternatively, the flow cell assembly 106 can be integrated into the reagent cartridge 104. In such implementations, the flow cell receptacle 142 may not be included or, at least, the flow cell assembly 106 may not be removably receivable within the reagent cartridge 104.

Referring now to the drive assembly 115, in the implementation shown, the drive assembly 115 includes the pump drive assembly 118, the valve drive assembly 120, and the pressure drive assembly 122. The pump drive assembly 118 is adapted to interface with one or more pumps 168 to pump fluid through the reagent cartridge 104. The pump 168 may be implemented by a syringe pump, a peristaltic pump, a diaphragm pump, etc. While the pump 168 may be positioned between the flow cell assembly 106 and the waste reservoir 116, in other implementations, the pump 168 may be positioned upstream of the flow cell assembly 106 or omitted entirely.

Referring to the controller 110, in the implementation shown, the controller 110 includes a user interface 170, a communication interface 172, one or more processors 174, and a memory 176 storing instructions executable by the one or more processors 174 to perform various functions including the disclosed implementation. The user interface 170, the communication interface 172, and the memory 176 are electrically and/or communicatively coupled to the one or more processors 174.

In an implementation, the user interface 170 is adapted to receive input from a user and to provide information to the user associated with the operation of the system 100 and/or an analysis taking place. The user interface 170 may include a touch screen, a display, a key board, a speaker(s), a mouse, a track ball, and/or a voice recognition system. The touch screen and/or the display may display a graphical user interface (GUI).

In an implementation, the communication interface 172 is adapted to enable communication between the system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 174 and/or the system 100 may include one or more of a processor-based system(s) or a microprocessor-based system(s). In some implementations, the one or more processors 174 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

The memory 176 may store one or more reference flow rate values, threshold ranges, and other related data. The memory 176 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache, and/or any other storage device or storage disk in which information is stored for any duration (e.g., permanently, temporarily, for extended periods of time, for buffering, for caching).

FIG. 1B illustrates a schematic diagram of another implementation of the system 100 of FIG. 1A. In the implementation shown, the system 100 includes the reagent cartridge receptacle 102. The flow cell assembly 106 is included. The reagent cartridge 104 is also included. The reagent cartridge 104 is receivable within the reagent cartridge receptacle 102 and is adapted to carry the flow cell assembly 106. The reagent cartridge 104 includes the reagent reservoir 136 and is fluidically coupled to the flow cell assembly 106. The sensor module 108 is also included. The sensor module 108 may be carried by the system 100 and/or by the reagent cartridge 104. The sensor module 108 may be positioned adjacent the reagent reservoir 136. In operation, the sensor module 108 may generate a signal associated with a volume of reagent contained within the reagent reservoir 136.

FIG. 1C illustrates another implementation of the flow cell assembly 106 and the reagent cartridge 104 of the system 100 of FIG. 1A. In the implementation shown, the flow cell assembly 106 and the reagent cartridge 104 are included. The reagent cartridge 104 is adapted to carry the flow cell assembly 106. The reagent cartridge 104 includes the reagent reservoir 138 fluidically coupled to the flow cell assembly 106. The sensor electrode 145 is associated with the generation of a signal associated with at least one of a volume of reagent within the reagent reservoir 136, a presence of reagent, or a reagent flow rate value. The presence of reagent may be identified within the reagent fluidic path 140, the common fluidic path 138, and/or in an area outside of the reagent reservoir 136, the reagent fluidic path 140, and/or the common fluidic path 138. The presence of reagent outside of a reservoir or fluidic path may be associated with a leak.

FIG. 2 is a schematic illustration of an implementation of the sensor module 108 and the sensor electrode 145 of FIG. 1. The sensor module 108 and the sensor electrode 145 may be carried by the system 100. In the implementation shown, the sensor electrode 145 includes a pair of plates 177. The plates 177 are spaced apart a distance 178. One of the reagent reservoirs 136 is shown positioned between the plates 177. The plates 177 may be positioned above or below the reagent reservoir 136 or the plates 177 may be positioned about the reagent reservoir 136. When the plates 177 are positioned about the reagent reservoir 136, the plates 177 may be positioned on the sides of the reagent reservoir 136 or the plates 177 may be positioned above and below the reagent reservoir 136.

Regardless of the relative position of the plates 177 and the reagent reservoir 136, the sensor module 108 and the plates 177 may be adapted to generate a signal associated with an amount of reagent (or other fluid) within the reagent reservoir 136. The amount of reagent determined within the reagent reservoir 136 may be used to determine the flow rate of the reagent (e.g., volume over time).

FIG. 3 is a schematic illustration of another implementation of the sensor module 108 and the sensor electrode 145 of FIG. 1. The sensor module 108 and the sensor electrode 145 may be carried by the system 100. In the implementation shown, the sensor electrode 145 includes an annular electrode 179. The annular electrode 179 may be referred to as a ring electrode. The annular electrode 179 is shown surrounding one of the reagent reservoirs 136. Because of the symmetry of the annular electrode 179, alignment between the annular electrode 179 and the reagent reservoir 136 may be consistently achieved. Thus, the annular electrode 179 may account for manufacturing tolerances including manufacturing tolerances of the reagent reservoir 136.

The annular electrode 179 may be positioned above or below the reagent reservoir 136 or the annular electrode 179 may be positioned about the reagent reservoir 136. When the annular electrode 179 is positioned about the reagent reservoir 136, the annular electrode 179 may be guided about the reagent reservoir 136 when, for example, the reagent cartridge 104 is being locked and/or loaded within the system 100. Other methods of positioning the annular electrode 179 relative to the reagent reservoir 136 may prove suitable to position the annular electrode 179 in a manner such that the sensor module 108 and the annular electrode 179 are able to generate a signal associated with an amount of reagent (or other fluid) within the reagent reservoir 136.

FIG. 4 is a schematic illustration of another implementation of the sensor module 108 and the sensor electrode 145 of FIG. 1. In the implementation shown, the sensor electrode 145 includes the conductor 152 and the connector 146 includes the contact 154. In an implementation, the conductor 152 is conductive tape and the contact 154 is a leaf spring electrical contact. The conductive tape may include Aluminum.

In another implementation, the conductor 152 includes a portion of the reagent reservoir 136 and the contact 154 is a leaf spring electrical contact. The portion may be a conductive plastic. In such implementations, the reagent reservoir 136 may be formed in a two-step injection molding process. Other methods of forming the reagent reservoir 136 may prove suitable. As an alternative, the reagent cartridge 104 may include the portion. Regardless of how the conductor 152 and/or the contact 154 are formed, the contact 154 may be adapted to contact the conductor 152 to communicatively couple the conductor 152 and the contact 154.

FIG. 5 is a schematic illustration of another implementation of the sensor module 108 and the sensor electrode 145 of FIG. 1. In the implementation shown, the sensor electrode 145 includes a pair of conductors 152 and the connector 146 includes a pair of contacts 154. The electrical field generated by the pair of conductors 152 may be different than the electrical field generated by the single conductor 152 of FIG. 4.

The conductors 152 may be a pair of wells 180 coupled and/or adjacent to the reagent reservoir 136. The wells 180 may be filled with a conductive fluid 182. The conductive fluid 182 may include adhesive, adhesive in a hardened state, Gallium, Mercury, an electrically conductive adhesive, a sliver epoxy adhesive, a conductive gel, alumina adhesive, thermal adhesive, and/or a conductive adhesive gel. Other conductive fluids may prove suitable.

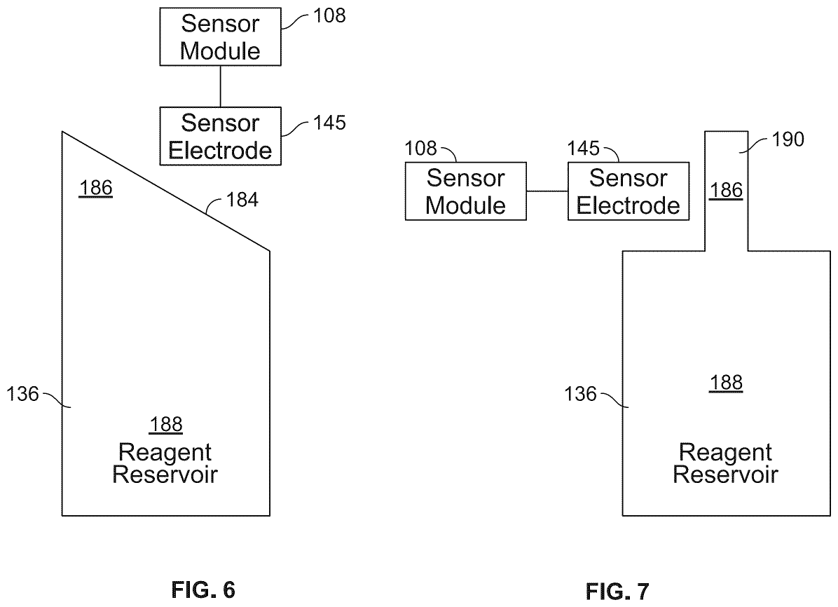

FIG. 6 is a schematic illustration of the reagent reservoir 136, the sensor module 108, and the sensor electrode 145 of FIG. 1. In the implementation shown, the reagent reservoir 136 includes a tapered portion 184. The sensor module 108 is arranged to determine a characteristic of the reagent within the reagent reservoir 136. A first volume 186 of reagent adjacent the tapered portion 184 is less than a second volume 188 in a remainder of the reagent reservoir 136. The tapered portion 184 reduces the amount of reagent within the first volume 186. Thus, a change in height of the reagent within the first volume 186 occurs more quickly than in the second volume 188, allowing for the reagent flow rate value to be determined relatively quickly by monitoring the first volume 186. As a result, in some implementations, the system 100 may perform a calibration process during normal run conditions as opposed to performing a separate calibration process prior to the normal run beginning.

FIG. 7 is a schematic illustration of another implementation of the reagent reservoir 136, the sensor module 108, and the sensor electrode 145 of FIG. 1. In the implementation shown, the reagent reservoir 136 includes an elongated portion 190. The sensor module 108 is arranged to determine a characteristic of the reagent within the reagent reservoir 136. The first volume 186 of reagent adjacent the elongated portion 190 is less than the second volume 188 in the remainder of the reagent reservoir 136, allowing for the controller 110 to determine and adjust the flow rate by monitoring the reagent flow rate value from the first volume 186 during normal run conditions. However, a separate calibration process may be performed here or in any of the other disclosed implementations.

FIG. 8 is an implementation of the reagent reservoir 136 of FIG. 1. In the implementation shown, the reagent reservoir 136 includes a curved portion 192 and a flat portion 194. The sensor electrode 145 and/or the sensor module 108 may be positioned adjacent the flat portion 194. Positioning the conductor 152 and/or 185, the sensor electrode 145, and/or the sensor module 108 adjacent the flat portion 194 may increase an accuracy of the volume determined and/or the reagent flow rate value determined because it may be easier to monitor a height of the reagent at the flat portion 194, as compared to the curved portion 192.

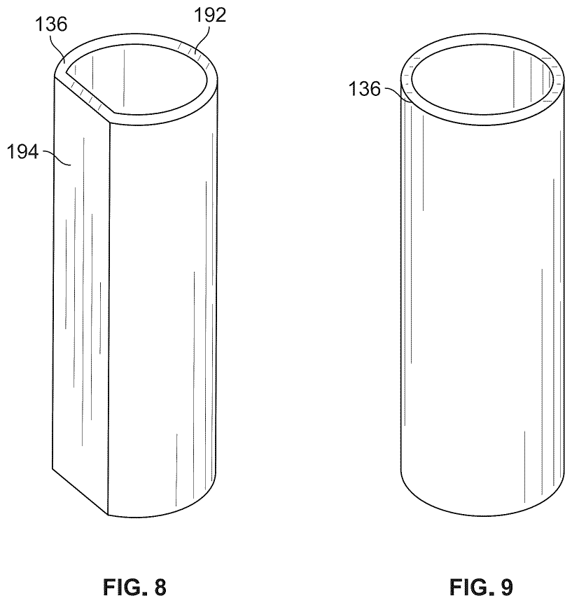

FIG. 9 is another implementation of the reagent reservoir 136 of FIG. 1. In the implementation shown, the reagent reservoir 136 has a circular cross-section. Other cross-sections may prove suitable.

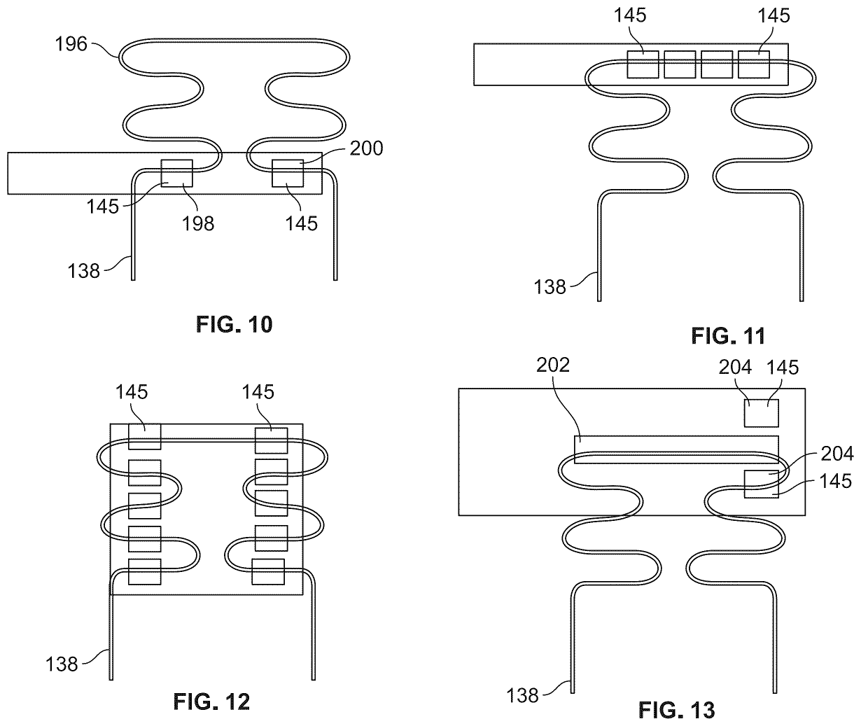

FIGS. 10-12 depict different example arrangement implementations of the sensor electrodes 145 positioned adjacent to an implementation of the common fluidic line 138 of FIG. 1. The sensor electrodes 145 may alternatively be positioned adjacent one or more of the reagent fluidic lines 140.

FIG. 10 illustrates a pair of the sensor electrodes 145 spaced apart and positioned adjacent the implementation of the common fluidic line 138 of FIG. 1. A volume 196 between the sensor electrodes 145 is known. The capacitance value associated with the sensor electrodes 145 may change when reagent within the common fluidic line 138 is adjacent to the corresponding sensor electrode 145.

To determine a reagent flow rate value, an amount of time that lapses is determined between when a capacitance value of a first electrode 198 changes and when a capacitance value of a second electrode 200 changes. The capacitance value may change when reagent within the common fluidic line 138 is adjacent to the corresponding sensor electrode 145. To determine the flow rate within the common fluidic line 138, the volume 196 between the sensor electrodes 145 is divided by the time associated with the capacitance values changing. Other methods of determining the flow rate may prove suitable.

Additionally, the sensor electrode 145 may be used to detect the presence of reagent or another fluid. For example, the presence of the reagent may be detected when a capacitance value of the first electrode 198 changes.

FIG. 11 illustrates an array of sensor electrodes 145 positioned adjacent the common fluidic line 138 of FIG. 10. The sensor electrodes 145 may be coupled to the reagent cartridge 104 and/or the system 100.

To determine a volume of fluid that has flowed in the common fluidic line 138, in an implementation, the capacitance value of the respective sensor electrodes 145 is monitored. For example, if the capacitance value of the first two sensor electrodes 145 changes, the controller 110 can determine that an associated volume of the reagent has been pumped and/or flowed through a portion of the common fluidic line 138. Similarly, if the capacitance value of the first three sensor electrodes 145 changes, the controller 110 can determine that an associated volume of the reagent has been pumped and/or flowed through another portion of the common fluidic line 138. While four sensor electrodes 145 are shown, any number of electrodes may be included. Determining the volume of the reagent may be used to ensure that the reagents are mixed a threshold amount, a threshold volume of reagent is provided, reagent is rehydrated a threshold amount (e.g., reagent initialization), and/or a threshold concentration of reagent is achieved.

In implementations when the sensor electrodes 145 are also positioned adjacent the reagent reservoir 136, the controller 110 can compare the signals from the different sensor electrodes 145 to monitor an operational status of the fluidics analysis operation. For example, the controller 110 can determine if a fluidics analysis operation is being conducted as expected.

FIG. 12 illustrates another array of the sensor electrodes 145 positioned adjacent the common fluidic line 138 of FIG. 10. While ten sensor electrodes 145 are shown, any other number of sensor electrodes 145 may be included. The capacitance values associated with the sensor electrodes 145 may be used to determine a reagent flow rate value, a volume of reagent within the common fluidic line 138, and/or a volume of the reagent pumped. However, the capacitance values may be used in other ways.

FIG. 13 illustrates another arrangement of the sensor electrodes 145 adjacent the common fluidic line 138 of FIG. 10. In the implementation shown, the sensor electrodes 145 include a longer electrode 202 and a pair of reference sensor electrodes 204. One of the reference sensor electrodes 204 may be spaced from the common fluidic line 138 and another of the reference sensor electrodes 204 may be positioned over top of or otherwise adjacent to the common fluidic line 138. The reference sensor electrodes 204 may be used to allow the controller 110 to determine a reference capacitance value when the reference sensor electrode 204 is not exposed to or is otherwise spaced from the reagent that may flow through the common fluidic line 138.

A capacitance value associated with the longer electrode 202 may be used to determine the volume of the reagent within the common fluidic line 138. The change of the capacitance value over time may be associated with the reagent flow rate value through the common fluidic line 138.

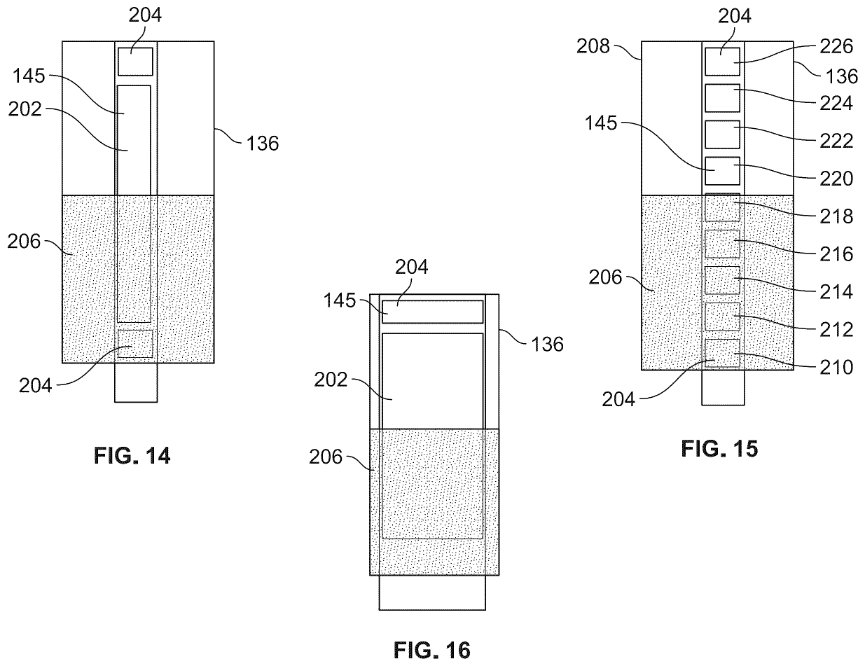

FIG. 14 illustrates an arrangement of the sensor electrodes 145 adjacent an implementation of the reagent reservoir 136 of FIG. 1. In the implementation shown, the longer electrode 202 has a relatively thin width. Providing the longer electrode 202 with a relatively thin width may reduce the likelihood of the longer electrode 202 being misaligned relative to the reagent reservoir 136. One of the reference sensor electrodes 204 is spaced from reagent 206 and another one of the reference sensor electrodes 204 is positioned adjacent the reagent 206.

FIG. 15 illustrates an array of the sensor electrodes 145 including the reference sensor electrodes 204 that are positioned adjacent the reagent reservoir 136 of FIG. 14. Some of the sensor electrodes 145 that are positioned toward a top 208 of the reagent reservoir 136 may be used to determine if the reagent 206 has flowed downward and/or if the reagent 206 is suspended/stuck toward the top 208 of the reagent reservoir 136.

In the implementation shown, the capacitance value of the different sensor electrodes 145 may be associated with the volume of reagent 206 with the reagent reservoir 136. For example, a first electrode 210 may be associated with a first volume of reagent contained within the reagent reservoir 136, a second electrode 212 may be associated with a second volume of reagent contained within the reagent reservoir 136, a third electrode 214 may be associated with a third volume of reagent contained within the reagent reservoir 136, etc. Put another way, each electrode 145 of the array of electrodes 145 and its position relative to the reagent reservoir 136 may be associated with a particular volume of reagent. As a result, when a capacitive value of the electrodes 210-214 change and the capacitive value of the remaining electrodes 216, 218, 220, 222, 224, 226 does not change, the controller 110 may determine that a particular volume of reagent 206 is contained within the reagent reservoir 136 associated with the first three electrodes 210, 212, 214. In such implementations, the electrodes 145 may act as on/off switches or may otherwise be tripped when reagent or a fluid is sensed. Moreover, the capacitance value may be indicative of the reagent 206 being stuck toward and/or on the top 208 of the reagent reservoir 136. For example, when the capacitive value of the top electrode 226 is indicative of reagent being present and others of the electrodes 220, 222, and 224 have a capacitive value indicative of reagent not being present, the controller 110 may determine that some of the reagent is stuck toward the top 208 of the reagent reservoir 136, or that there is otherwise an error in the determining and/or dispensing of the reagent.

FIG. 16 illustrates an arrangement of the sensor electrodes 145 adjacent the reagent reservoir 136 of FIG. 14. The arrangement of FIG. 16 is similar to the arrangement of FIG. 14, but the sensor electrodes 145 are wider. Other widths and/or shapes of the sensor electrodes 145 may prove suitable. Also, the lower reference sensor electrode 204 shown in FIG. 14 is not included in the implementation of FIG. 16. However, the lower reference sensor electrode 204 may alternatively be included in the implementation of FIG. 16.

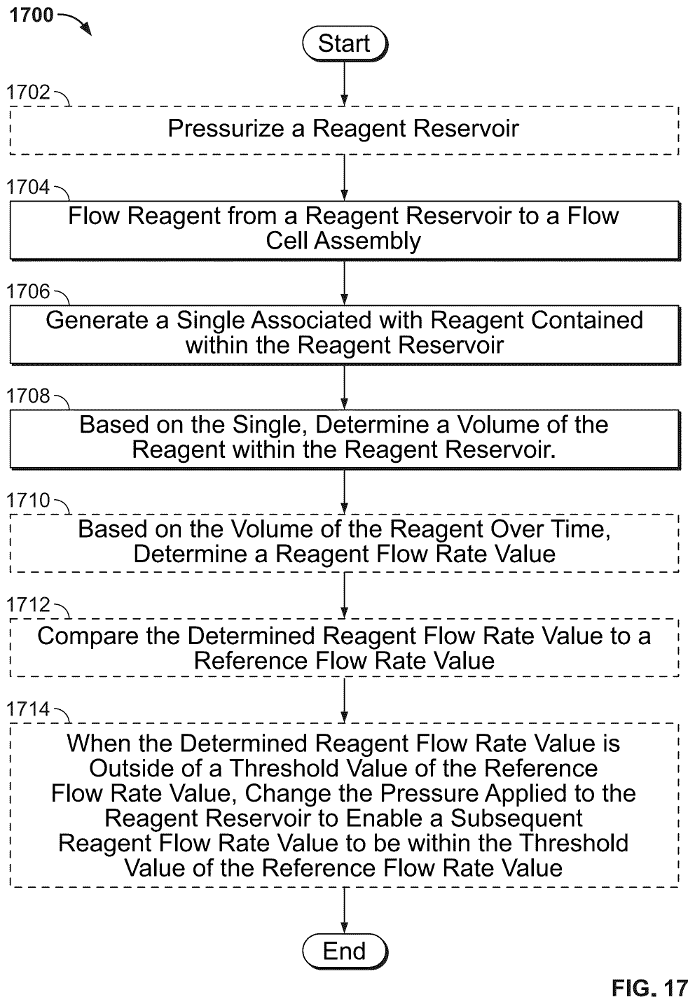

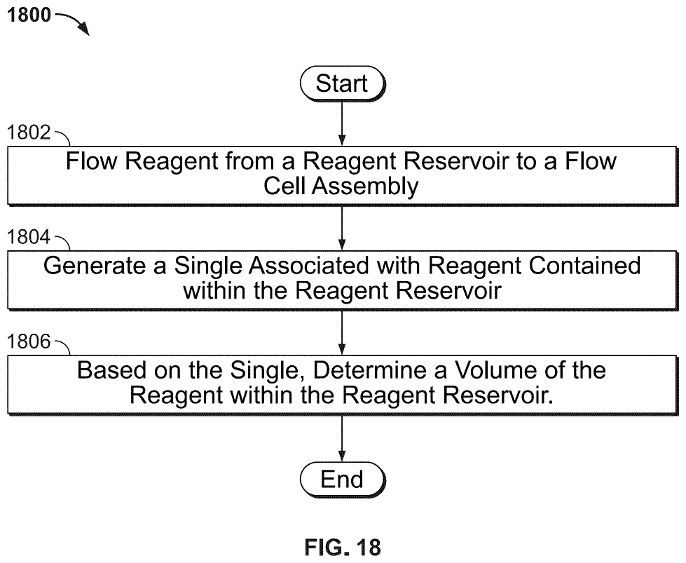

FIGS. 17 and 18 illustrates flowcharts for methods of determining a volume of reagent within the reagent reservoir 136 using the system 100 of FIG. 1A or any of the other implementations disclosed herein. In the flow chart of FIG. 17, the blocks surrounded by solid lines may be included in an implementation of a process 1700 while the blocks surrounded in dashed lines may be optional in the implementation of the process. However, regardless of the way the border of the blocks is presented in FIGS. 17 and 18, the order of execution of the blocks may be changed, and/or some of the blocks described may be changed, eliminated, combined and/or subdivided into multiple blocks.

Referring to FIG. 17, a process 1700 begins by pressurizing the reagent reservoir 136 (block 1702). The reagent reservoir 136 can be pressurized using the pressure source 112. Reagent is flowed from the reagent reservoir 136 to the flow cell assembly 106 (block 1704). A signal is generated in association with reagent contained within the reagent reservoir 136 (block 1706). The signal may be generated by the sensor module 108. A volume of the reagent within the reagent reservoir 136 is determined based on the signal (block 1708).

A reagent flow rate value is determined based on the volume of the reagent over time (block 1710). The determined reagent flow rate value is compared to a reference flow rate value (block 1712). When the determined reagent flow rate value is outside of a threshold range of the reference flow rate value, the pressure applied to the reagent reservoir 136 is changed to enable a subsequent reagent flow rate value to be within the threshold range of the reference flow rate value (block 1714).

In another implementation, a reagent flow rate value is determined based on the volume of the reagent over time. The determined reagent flow rate value is compared to a reference flow rate value. The pressure applied to the reagent reservoir is changed to enable a subsequent reagent flow rate value to be closer to the reference flow rate value.

Referring to FIG. 18, a process 1800 begins with reagent being flowed from the reagent reservoir 136 to the flow cell assembly 106 (block 1802). A signal is generated in association with reagent contained within the reagent reservoir 136 (block 1804). The signal may be generated by the sensor module 108. A volume of the reagent within the reagent reservoir 136 is determined based on the signal (block 1806).

An apparatus, comprising: a system including a reagent cartridge receptacle; a flow cell assembly; a reagent cartridge receivable within the reagent cartridge receptacle and adapted to carry the flow cell assembly, the reagent cartridge comprising a reagent reservoir adapted to be fluidically coupled to the flow cell assembly; and a sensor module adapted to be positioned adjacent the reagent reservoir, wherein the sensor module is adapted to generate a signal associated with a volume of reagent contained within the reagent reservoir.

The apparatus of any one or more of the preceding implementations and/or any one or more of the implementations disclosed below, wherein the system comprises a controller adapted to access the signal from the sensor module, and wherein the controller is adapted to determine a flow rate from the reagent reservoir based on the volume within the reagent reservoir over time.

The apparatus of any one or more of the preceding implementations and/or any one or more of the implementations disclosed below, wherein the controller is adapted to compare the determined reagent flow rate value to a reference flow rate value, and wherein when the determined reagent flow rate value is outside of a threshold range of the reference flow rate value, the controller is adapted to change an operating parameter of the system.

The apparatus of any one or more of the preceding implementations and/or any one or more of the implementations disclosed below, wherein the operating parameter comprises an amount of time that the reagent is flowed from the reagent reservoir.

The apparatus of any one or more of the preceding implementations and/or any one or more of the implementations disclosed below, wherein the operating parameter comprises a pressure applied to the reagent reservoir.

The apparatus of any one or more of the preceding implementations and/or any one or more of the implementations disclosed below, further comprising a pressure source adapted to apply and may apply a pressure to the reagent reservoir.

The apparatus of any one or more of the preceding implementations and/or any one or more of the implementations disclosed below, further comprising a regulator coupled between the pressure source and the reagent reservoir and wherein the controller is adapted to cause and may cause the regulator to change the pressure applied to the reagent reservoir.

The apparatus of any one or more of the preceding implementations and/or any one or more of the implementations disclosed below, wherein the system comprises the sensor module.

The apparatus of any one or more of the preceding implementations and/or any one or more of the implementations disclosed below, further comprising a sensor electrode adapted to be communicatively coupled and may be communicatively coupled to the sensor module.

The apparatus of any one or more of the preceding implementations and/or any one or more of the implementations disclosed below, wherein the sensor electrode is wirelessly coupled to the sensor module.

The apparatus of any one or more of the preceding implementations and/or any one or more of the implementations disclosed below, further comprising a connector adapted to couple and may couple the sensor module and the sensor electrode.

The apparatus of any one or more of the preceding implementations and/or any one or more of the implementations disclosed below, wherein the connector comprises a male portion and a female portion, one of the male portion or the female portion carried by reagent cartridge, the other of the male portion or the female portion carried by the system.

The apparatus of any one or more of the preceding implementations and/or any one or more of the implementations disclosed below, wherein the sensor electrode comprises a pair of plates between which the reagent reservoir is adapted to be positioned.

The apparatus of any one or more of the preceding implementations and/or any one or more of the implementations disclosed below, wherein the sensor electrode is an annular electrode and is adapted to surround and does surround the reagent reservoir.

The apparatus of any one or more of the preceding implementations and/or any one or more of the implementations disclosed below, wherein the sensor electrode is carried by the reagent cartridge.

The apparatus of any one or more of the preceding implementations and/or any one or more of the implementations disclosed below, wherein the sensor module comprises a contact adapted to interface with the sensor electrode.

The apparatus of any one or more of the preceding implementations and/or any one or more of the implementations disclosed below, wherein the contact comprises a leaf spring contact.

An apparatus, comprising: a flow cell assembly; a reagent cartridge adapted to carry and does carry the flow cell assembly, the reagent cartridge comprising: a reagent reservoir adapted to be fluidically coupled to the flow cell assembly; and a sensor electrode associated with the generation of a signal associated with at least one of a volume of reagent within the reagent reservoir, a presence of reagent, or a reagent flow rate value.

The apparatus of any one or more of the preceding implementations and/or any one or more of the implementations disclosed below, wherein the reagent cartridge comprises a fluidic line and the sensor electrode is positioned adjacent the fluidic line.

The apparatus of any one or more of the preceding implementations and/or any one or more of the implementations disclosed below, wherein the sensor electrode comprises conductive tape coupled to the reagent cartridge.

The apparatus of any one or more of the preceding implementations and/or any one or more of the implementations disclosed below, wherein the sensor electrode comprises a portion of the reagent reservoir or the reagent cartridge.

The apparatus of any one or more of the preceding implementations and/or any one or more of the implementations disclosed below, wherein the sensor electrode comprises a well filled with a conductive fluid and is adjacent to the reagent reservoir.

The apparatus of any one or more of the preceding implementations and/or any one or more of the implementations disclosed below, wherein the reagent reservoir comprises a tapered portion.

The apparatus of any one or more of the preceding implementations and/or any one or more of the implementations disclosed below, wherein the reagent reservoir comprises an elongated portion.

A method, comprising: flowing reagent from a reagent reservoir to a flow cell assembly; generating a signal associated with reagent contained within the reagent reservoir; and based on the signal, determining a volume of the reagent within the reagent reservoir.

The method of any one or more of the preceding implementations and/or any one or more of the implementations disclosed below, further comprising based on the volume of the reagent over time, determining a reagent flow rate value.

The method of any one or more of the preceding implementations and/or any one or more of the implementations disclosed below, further comprising pressurizing the reagent reservoir.

The method of any one or more of the preceding implementations and/or any one or more of the implementations disclosed below, further comprising comparing the determined reagent flow rate value to a reference flow rate value; and when the determined reagent flow rate value is outside of a threshold range of the reference flow rate value, changing the pressure applied to the reagent reservoir to enable a subsequent reagent flow rate value to be within the threshold range of the reference flow rate value.

The method of any one or more of the preceding implementations and/or any one or more of the implementations disclosed below, wherein the signal is associated with a height of the reagent contained within the reagent reservoir.

The method of any one or more of the preceding implementations and/or any one or more of the implementations disclosed below, wherein the signal is associated with a volume of the reagent contained within the reagent reservoir.

The method of any one or more of the preceding implementations and/or any one or more of the implementations disclosed below, wherein the signal is associated with a flow rate of the reagent dispensed from the reagent reservoir.

The method of any one or more of the preceding implementations and/or any one or more of the implementations disclosed below, the signal is associated with an electrode of an array of electrodes, each electrode of the array of electrodes being positioned adjacent the reagent reservoir and being associated with a different volume of reagent within the reagent reservoir.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

While certain implementations describe a single reagent reservoir, other implementations contemplated herein include multiple reagent reservoirs. Likewise, multiple sensor modules and/or sensor electrodes may be used for single or multiple reagent reservoirs to determine one or more flow rates, as may prove suitable.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

What is claimed is:

1. A method, comprising:
flowing reagent from a reagent reservoir to a flow cell assembly;
generating a signal associated with reagent contained within the reagent reservoir; and
based on the signal, determining a volume of the reagent within the reagent reservoir.

2. The method of claim 1, further comprising based on the volume of the reagent over time, determining a reagent flow rate value.

3. The method of claim 2, further comprising pressurizing the reagent reservoir.

4. The method of claim 3, further comprising comparing the determined reagent flow rate value to a reference flow rate value; and when the determined reagent flow rate value is outside of a threshold range of the reference flow rate value, changing a pressure applied to the reagent reservoir to enable a subsequent reagent flow rate value to be within the threshold range of the reference flow rate value.

5. The method of claim 1, wherein the signal is associated with a height of the reagent contained within the reagent reservoir.

6. The method of claim 1, wherein the signal is associated with an electrode of an array of electrodes, each electrode of the array of electrodes being positioned adjacent the reagent reservoir and being associated with a different volume of reagent within the reagent reservoir.

7. A method, comprising:
flowing a reagent from a reagent reservoir to a flow cell assembly, where a reagent cartridge comprises the reagent reservoir and the flow cell assembly, where the reagent cartridge is removably housed within a reagent cartridge receptacle of a nucleic acid sequencing system, where the nucleic acid sequencing system comprises a sensor electrode;
generating a signal associated with the reagent contained within the reagent reservoir using the sensor electrode; and
determining a volume of the reagent within the reagent reservoir based on the signal.

8. The method of claim 7, further comprising:
generating a second signal associated with the reagent contained within the reagent reservoir using the sensor electrode;
determining a second volume of the reagent within the reagent reservoir based on the second signal; and
determining a reagent flow rate based on the volume of the reagent and the second volume of the reagent.

9. The method of claim 8, further comprising:
changing a pressure applied to the reagent reservoir when the determined reagent flow rate is outside of a threshold range of flow rate values.

10. The method of claim 7, further comprising:
pressurizing the reagent reservoir.

11. The method of claim 7, wherein the signal varies based upon a height of the reagent contained within the reagent reservoir.

12. The method of claim 7, wherein generating the signal associated with the reagent contained within the reagent reservoir further comprises using an array of electrodes positioned adjacent the reagent reservoir.

13. The method of claim 7, wherein the reagent reservoir comprises a tapered portion.

14. The method of claim 7, wherein the sensor electrode comprises a pair of plates between which the reagent reservoir is positioned.

15. An apparatus, comprising:
a reagent cartridge adapted to carry a flow cell assembly, the reagent cartridge comprising:
a reagent reservoir adapted to be fluidically coupled to the flow cell assembly; and
a sensor electrode associated with the generation of a signal associated with at least one of a volume of reagent within the reagent reservoir, a presence of reagent, or a reagent flow rate value.

16. The apparatus of claim 15, further comprising the flow cell assembly, where the reagent reservoir is fluidically coupled to the flow cell assembly.

17. The apparatus of claim 15, wherein the sensor electrode comprises conductive tape coupled to the reagent cartridge.

18. The apparatus of claim 15, wherein the sensor electrode comprises a well filled with a conductive fluid and is adjacent to the reagent reservoir.

19. The apparatus of claim 15, wherein the reagent reservoir comprises a tapered portion.

20. The apparatus of claim 15, wherein the sensor electrode is adjacent to the reagent reservoir.
